(19) United States
(12) Patent Application Publication
(10) Pub. No.: US 2015/0154698 A1
(43) Pub. Date: Jun. 4, 2015

(54) Hybridization of Personal and Business Credit and Credibility

(71) Applicant: Credibility Corp., Malibu, CA (US)

(72) Inventors: Jeffrey M. Stibel, Malibu, CA (US); Peter Delgrosso, Malibu, CA (US); Moujan Kazerani, Santa Monica, CA (US)

(73) Assignee: Credibility Corp.

(21) Appl. No.: 14/447,949

(22) Filed: Jul. 31, 2014

Related U.S. Application Data
(60) Provisional application No. 61/911,411, filed on Dec. 3, 2013.

(51) Int. Cl. G06Q 40/02

(52) U.S. Cl. CPC G06Q 40/025

(57) ABSTRACT

Some embodiments provide a system that removes the delineation between credit and credibility and between the personal and business aspects of each. The system constructs an individual-business tuple for an entity. The tuple stores credit and credibility information for the entity and other entities that are associated with the entity. When the entity is a business, the tuple stores credit and credibility information for individuals that can affect creditworthiness of the business. When the entity is an individual, the tuple stores credit and credibility information for businesses that can affect the creditworthiness of the individual. The entity's credit can then be evaluated by shopping the information to loan originators, using the associated information to fill gaps in credit information of the entity, producing a holistic report, and deriving a hybrid credit score based on some combination of the credit and credibility information from the tuple.

### CLAIM OF BENEFIT TO RELATED APPLICATION

This application claims the benefit of U.S. provisional application 61/911,411 entitled “Hybridization of Personal and Business Credit”, filed Dec. 3, 2013. The contents of application 61/911,411 are hereby incorporated by reference.

### TECHNICAL FIELD

The present invention pertains to credit evaluation and lending.

### BACKGROUND

Lending is divided along personal and business lines. The terms and rates for individual lines of credit differ from those of business lines of credit. In no small part, this is because the information and criteria used to determine a personal line of credit is different than those used to determine a business line of credit.

Personal lines of credit are determined in some part from personal credit scores. Personal credit reporting agencies, such as TransUnion, Experian, and Equifax, derive personal credit scores from personal credit information including an individual's assets, debt, and prior payment history as some examples. One example of a personal credit score is the widely used FICO score.

Business lines of credit are determined in some part from business credit scores. Business credit reporting agencies, such as Dun & Bradstreet, derive business credit scores from business credit information as opposed to personal credit information. One example of a business credit score is the PAYDEX score. Though both the FICO score and PAYDEX score are used for credit evaluation, they are completely different metrics as the PAYDEX business credit score ranges from a value of 0 to 100, whereas the FICO personal credit score ranges from a value of 300 to 850.

The delineation between personal credit and business credit is in many respects artificial and complicates how capital is acquired. This delineation is perpetuated by the credit reporting agencies. Each credit reporting agency strives to become the defacto standard in credit evaluation. As such, the FICO score for personal credit and the PAYDEX score for business credit remain separate and independent of one another even though there is a large interplay between personal credit and business credit. One affects the other. More specifically, the credit information used in the derivation of one score can directly or indirectly affect the derivation of the other score.

Nevertheless, the delineation between personal credit and business credit remains. This delineation is especially harmful to new and small businesses. Such businesses do not have sufficient business credit information. Credit reporting agencies are therefore unable to make a proper risk assessment of the business. As such, new and small businesses are penalized for the lack of business credit information by way of a degraded business credit score. Consequently, new and small businesses are turned away, offered below average terms and lines of credit, or are required to provide some secondary assurance, such as a personal guarantee, in order to acquire the capital they need to operate. These issues can, however, be alleviated with a quick analysis of the personal credit of the business' principals. For instance, if the principals were proven leaders with well established credit histories demonstrating years of successful credit acquisition and repayment, then one can deduce that there is a lower risk of lending to such a business than to a similar business with inexperienced principals that have poor personal credit of their own.

Alternatively, one can use credibility as a substitute or supplement to credit. Whereas credit is focused on the financial risk that is associated with an individual or business, credibility is a more holistic measure. Credibility has several different derivations, but in many cases, credibility is derived based on the experiences that others have had with an individual or business. These experiences can relate to matters such as financial risk, but also quality, responsiveness, cleanliness, timeliness, etc. As such, credibility can provide a measure that is in some respects more meaningful than credit when deciding whether or not to conduct business with, partner with, or lend to another. For example, a business may be financially stable and have a high credit rating. However, that same business may have bad credibility amongst its peers which can be an early warning that those peers will begin to transact less with that business, thereby providing an early indication of future credit issues. Thus, when credit information about an individual or business is lacking or even when credit information is available, it would be helpful to have credibility information on-hand for greater insight.

However, as with the delineation between personal and business credit, there is delineation between credit and credibility and between personal and business credibility. Credit reporting agencies do not include credibility information as part of their credit reports. Credibility reporting agencies are typically oriented to business credibility and do not provide credibility insight as to that business's principals, managers, or executives. This limits the true holistic value of the credibility information.

Accordingly, there is a need to improve the information that is available to lenders about potential borrowers. Specifically, there is a need to eliminate the artificial delineation between credit and credibility and especially between personal and business aspects of each. To do so, there is a need to synergize the two to better account for the interplay between credit and credibility and for the dependencies between business credit and personal credit and between personal credibility and business credibility. More generally, there is a need to leverage credibility information when deriving entity credit and to do so in a manner that incorporates related personal and business credibility to related personal and business credit. This then facilitates a more comprehensive evaluation of an entity.

### SUMMARY OF THE INVENTION

It is an objective of the present invention to define systems, methods, and computer software products to improve capital acquisition by removing the delineation between credit and credibility and by further removing the delineation between personal and business aspects of each. It is an objective to coalesce entity credit and credibility for the purpose of identifying the best terms and lines of credit that are available to the entity regardless of whether the credit is made available based on the entity's credit information, credibility information, or some combination thereof. Moreover, it is an objective to coalesce personal credit and business credit to yield a holistic account of credit. Similarly, it is an objective to coalesce personal credibility and business credibility to yield a holistic account of credibility.

To achieve these and other objectives, some embodiments set forth a hybrid entity evaluation system and methods. The system comprehensively evaluates an entity's creditworthiness and identifies the credit that is available to that entity according to some hybrid compilation of that entity's personal credit, business credit, personal credibility, and business credibility. The entity's credit and credibility are determined in part from the credit and credibility of various individuals and businesses that are associated with the entity and that influence the credit and credibility of the entity.

In order to holistically evaluate an entity, some embodiments identify an individual-business tuple for the entity. The tuple associates one or more individuals with the entity when the entity is initially identified as a business. More specifically, the tuple associates one or more individuals that are principals of the business. The principals can include persons directly influencing the day-to-day operations of the business and typically include persons in executive, directorial, or managerial capacities. Inversely, the tuple associates one or more businesses with the entity when the entity is initially identified as an individual, wherein the associated businesses are those directly influenced by the individual. An entity tuple is a data structure identifying at least one individual or person that is associated in some capacity to at least one business, wherein the individual and business influence or otherwise impact the creditworthiness of the entity in some capacity.

Next, the system populates the tuple with any available credit and credibility information for each individual and business associated with the tuple. Specifically, the system obtains the personal credit information and personal credibility information for any of the identified individuals of the tuple and business credit information and business credibility information for any of the identified businesses of the same tuple. The obtained information is linked to the proper individual or business of the individual-business tuple. Credit scores and credibility scores for the various individuals and businesses may also be linked to the tuple. As a result, the tuple not only holistically expresses creditworthiness of the entity represented by tuple and the associated individuals and businesses, but also the social presence, reputation, and trustworthiness of the entity and associated individuals and businesses as expressed through experiences that others have had with those parties.

The information linked to the tuple provides the system of some embodiments a broad base of information with which to evaluate the creditworthiness and capital availability for an entity relative to prior art methodologies that rely solely on the credit information of a single individual or a single business without consideration of the interplay of credit and credibility or the interplay between the personal and business aspects of each.

In some embodiments, the system produces hybrid personal information for each individual of the tuple based on that individual's personal credit information, personal credibility information, or some combination thereof. The hybrid personal information is then provided to various personal loan originators to determine the terms and lines of credit that each of these loan originators offers to the one or more individuals that are associated in the tuple for a given entity.

Similarly, some embodiments produce hybrid business information for each business of the tuple based on its business credit information, business credibility information, or some combination thereof. The hybrid business information is then provided to various business loan originators to determine the terms and lines of credit that each of these loan originators offers to the one or more businesses that are associated in the tuple for a given entity.

The system aggregates the offers from each loan originator and comprehensively and holistically presents the offers to the entity associated with the primary tuple in a single interface. In this manner, the entity can view its available personal credit and available business credit in one interface without having to separately shop its personal credit information and personal credibility information to each personal loan originator and separately shop its business credit information and business credibility information to each business loan originator.

Some embodiments compile the hybrid personal information with the hybrid business information from a particular entity tuple in order to produce a complete information set from which to evaluate the creditworthiness and credit availability for the particular entity. In some such embodiments, the system performs a gap filling methodology. The gap filling methodology supplements or substitutes an item of missing, obsolete, or lacking information with related information from a complimentary source within the same tuple. As some examples, the gap filling may involve using personal credibility information of a particular individual to complete the personal credit information profile of that particular individual, using personal credit information of a first individual associated with a tuple to complete the personal credit information profile of a second individual associated with the tuple, and using business credit information of a first or second individual associated with a tuple to complete the personal credit information of the first individual. The gap filling methodology yields a complete information set from which loan originators can evaluate the creditworthiness of an entity without penalizing the entity for missing or lacking items of information required by those loan originators.

In some embodiments, the system coalesces personal information with business information in order to produce a hybrid credit score. The hybrid credit score for a particular entity may be derived using the available personal credit information, business credit information, personal credibility information, business credibility information, or some combination thereof from within that entity's tuple. In some embodiments, the hybrid credit score is derived by coalescing personal credit scores and business credit scores that are associated with a given entity tuple. The scores can be averaged together or certain scores can be weighted more than other scores in order to derive the hybrid credit score. Personal credibility scores and business credibility scores can be used to supplement the hybrid credit score.

In some embodiments, the hybrid credit score is one that modifies a business credit score based on personal credit information (including personal credit scores) or business credibility information (including business credibility scores) from the same entity tuple, or inversely, modifies a personal credit score based on business credit information (including business credit scores) or personal credibility information (including personal credibility scores) from the same entity tuple. For example, the hybrid credit score may be keyed to a business PAYDEX credit score of a given entity tuple, and the hybrid credit score is then increased or decreased based on the personal credit information, personal credit scores, business credibility information, and/or business credibility scores from the same entity tuple.

In some embodiments, the system performs the above described gap filling methodology to compute the hybrid credit score. The system identifies from an entity tuple, the business credit information that is used to compute a business credit score for the entity represented by the tuple. The system then determines gaps in the business credit information. The system fills these gaps using supplemental information from a complimentary source including the personal credit information and business credibility information that is linked to the same tuple. The business credit score is then recomputed with the supplemental information, wherein the recomputed business credit score can be a new hybrid credit score or represented as a modified business credit score. An inverse internal gap filling methodology can be performed to compute a hybrid credit score or a modified personal credit score by supplementing gaps in personal credit information with supplemental information from a complimentary source within the same tuple including business credit information and personal credibility information.

In some embodiments, the hybrid credit score is provided to various loan originators to determine the capital that is available to the entity. The results are presented in a single interface, along with or independent of, the terms and lines of credit that are available based solely on the entity's personal information or business information. In this manner, the entity can easily identify and select the best available terms and line of credit.

Some embodiments generate holistic reports using the credit and credibility information from the entity tuple. Such a holistic report presents personal credit of an individual in conjunction with that individual's credibility and/or the business credit of one or more businesses that are associated with that individual. Inversely, the holistic credit report may present business credit of a business in conjunction with that business's credibility and/or the personal credit of one or more individuals that are associated with that business. As such, the report conveys the creditworthiness or then entity as well as its social presence, reputation, and trustworthiness. Intelligence can be embedded in the holistic report so as to identify where creditworthiness of the entity is weak and other areas where it is strong, including providing suggestions for how to improve the overall creditworthiness based on actions that impact that entity's credit or credibility or that of the individuals and businesses associated with the entity.

### BRIEF DESCRIPTION OF THE DRAWINGS

In order to achieve a better understanding of the nature of the present invention a preferred embodiment of the hybrid entity evaluation system will now be described, by way of example only, with reference to the accompanying drawings in which:

FIG. 1 presents a process for constructing and populating an individual-business tuple in accordance with some embodiments.

FIG. 2 conceptually presents a tuple in accordance with some embodiments.

FIG. 3 presents a process with which the system provides a holistic evaluation for an entity in accordance with some embodiments.

FIG. 4 presents an exemplary interface presenting a holistic evaluation of the entity in accordance with some embodiments.

FIG. 5 presents an exemplary holistic report that is derived based on the credit and credibility information from an individual-business tuple of some embodiments.

FIG. 6 presents an alternative holistic report that is keyed to a particular individual and that shows credit and credibility information of the particular individual as well as credit and credibility information for businesses whose creditworthiness the particular individual can influence.

FIG. 7 presents a process for performing the gap filling methodology in accordance with some embodiments.

FIG. 8 conceptually illustrates using the gap filling methodology to generate a revised credit score in accordance with some embodiments.

FIG. 9 illustrates deriving the hybrid credit score for an entity by adjusting an existing credit score of the entity based on credit and credibility scores of individuals or businesses that are associated with the entity in the same tuple.

FIG. 10 illustrates another methodology for deriving the hybrid credit score by adjusting an existing credit score using credit information and credibility information of individuals or businesses that are associated with the entity in the same tuple.

FIG. 11 presents a process for deriving the hybrid credit score by coalescing personal and business credit and credibility information.

FIG. 12 illustrates components of the hybrid entity evaluation system of some embodiments.

FIG. 13 illustrates a computer system with which some embodiments are implemented.

### DETAILED DESCRIPTION OF THE INVENTION

In the following detailed description, numerous details, examples, and embodiments of a hybrid entity evaluation system and methods are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

Various terminology is defined to aid in the disclosure of the hybrid entity evaluation system. The term entity is used to interchangeably refer to an individual and a business, wherein the individual is a natural person. An entity database is a database that stores identifying information about different businesses and individuals. Some such databases are maintained by credit reporting agencies, data aggregators, social media sites, and directories as some examples (e.g., LinkedIn, Spoke, etc.). Some such identifying information includes identifying which businesses an individual is associated with and the principals of a business. A principal can be a business owner, business founder, investor, or an individual that directly influences the day-to-day operations of a business, such as a person in executive, directorial, or managerial capacities as some examples. A loan originator includes any lender that offers terms and lines of credit to an entity. The loan originator can be a bank, credit card agency, mortgage broker, or other lending institution. A credit reporting agency is a business involved in credit information aggregation and credit reporting. Some credit reporting agencies for personal credit include Experian, Equifax, and TransUnion. Personal credit is often quantified as a FICO credit score, however the following disclosure is applicable to other personal credit scores as well. A credit reporting agency for business credit includes Dun & Bradstreet. Business credit is often quantified as a PAYDEX credit score, however the following disclosure is applicable to other business credit scores as well. Credit and creditworthiness are fundamentally measures of risk relating to the ability of an entity to pay its debt. Credit is derived from many factors include debt, revenue, lines of credit, and payment timeliness as some examples. Credibility is a measure of reputation as perceived by others that have engaged with or that have had an experience with an entity whose credibility is at issue. Credibility can be derived from those experiences as well as sentiment, ratings, influence, presence, accreditations, etc.

I. Overview

The hybrid entity evaluation system and methods of some embodiments comprehensively evaluates an entity's creditworthiness and identifies that entity's credit availability according to some hybrid compilation of that entity's personal credit, business credit, personal credibility, and business credibility. The entity's credit and credibility are determined in part from the credit and credibility of various individuals and businesses that are associated with the entity and that influence the credit and credibility of the entity. In so doing, the system removes the delineation between credit and credibility and the personal and business aspects of each. With these divisions removed, the system is able to comprehensively identify all credit that is available to the entity from a single interface. The system can then recommend the best available terms and lines of credit that are available to the entity irrespective of whether such credit is offered on the basis of that entity's personal credit information, personal credibility information, business credit information, business credibility information, or some combination thereof including the credit and credibility of those individuals and businesses associated with the entity.

Some embodiments compile the personal and business credit and credibility information of an entity to represent the creditworthiness of the entity more comprehensively than prior art methodologies that rely on just personal credit or just business credit in determining an entity's creditworthiness. In some embodiments, the system supplements gaps of business credit information with germane business credibility information and/or personal credit information, and inversely, supplements gaps of personal credit information with germane personal credibility information and/or business credit information. Each gap resulting from incomplete, unavailable, or obsolete information in an entity's credit profile detrimentally impacts the creditworthiness of the entity. Specifically, each gap adds to the uncertainty as to whether or not the entity can fulfill its obligations on a loan. However, the interplay between credit and credibility as well as the interplay between personal credit and business credit, whereby changes to one indirectly or directly affects the other, allows for the coalescing of credit and credibility and the personal and business aspects of each.

In some embodiments, the system generates a hybrid credit score from the compilation of credit and credibility and the personal and business aspects of each. The hybrid credit score can be a separate metric than existing personal credit scores and business credit scores. Alternatively, the hybrid credit score can be a modification of a personal credit score or a business credit score. When modifying an existing score, the system can increase or decrease an existing personal credit score for an individual based on business credit and credibility information for businesses that are associated with that individual. Inversely, the system can increase or decrease an existing business credit score for a business based on personal credit and credibility information for individuals associated with that business. In some embodiments, the system computes the hybrid credit score using a gap filling procedure, whereby the credit information used to compute the score is obtained and any insufficient or lacking credit information is supplemented with credit or credibility information from a complimentary source such that the score can be recomputed with a complete and comprehensive set of credit information. In any case, the hybrid score provides a more accurate and comprehensive evaluation of entity creditworthiness and risk as the score accounts for the interplay between credit and credibility as well as personal and business aspects of each.

Personal and business credit and credibility can be combined to also provide reports that holistically convey the creditworthiness, social presence, reputation, and trustworthiness of the entity and associated individuals and businesses. For example, the reports may present the personal credit of an individual in conjunction with that individual's credibility and the business credit of one or more businesses that are associated with that individual. Inversely, the reports may present business credit of a business in conjunction with the personal credit and credibility of one or more individuals that are associated with that business. Intelligence can be embedded in a holistic report so as to identify specific areas where an entity's credit or credibility are weak and other areas where it is strong, including providing suggestions for how to improve the weaker areas in order to improve the entity's overall creditworthiness.

II. Individual-Business Tuple

The first step in coalescing an entity's credit and credibility and the personal and business aspects of each is to identify the one or more individuals and businesses that contribute to or influence the creditworthiness of that entity. These individuals and businesses are associated with an individual-business tuple that the system creates for that entity.

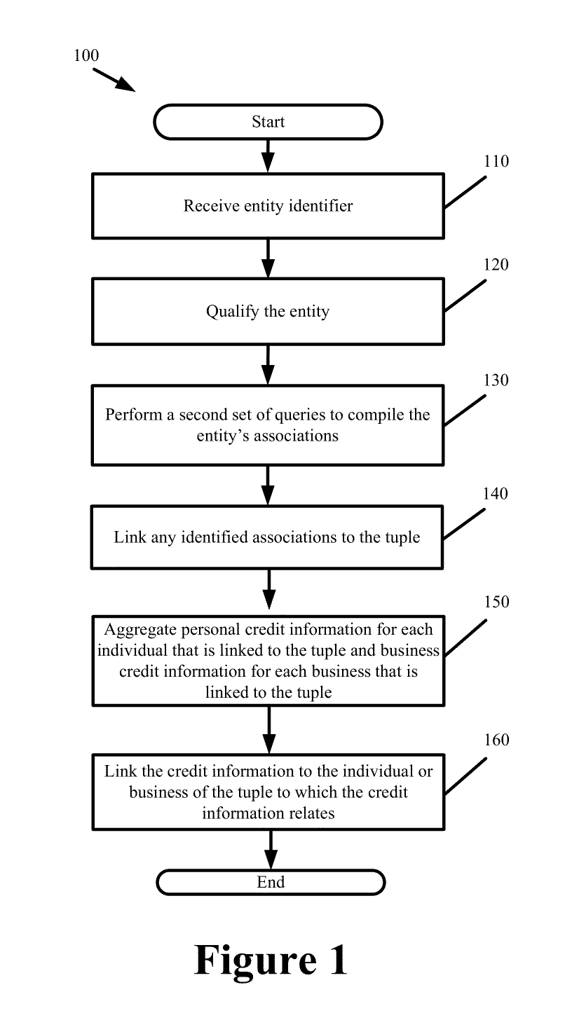

FIG. 1 presents a process 100 for constructing and populating an individual-business tuple in accordance with some embodiments. The process is performed by the hybrid entity evaluation system of some embodiments using at least one processor of a computer or machine. The tuple and the associated information for the tuple are stored as a data structure to a non-transitory computer-readable storage medium of the computer or machine.

The process commences by receiving (at 110) an identifier. The identifier identifies an entity for which a tuple is to be constructed. The identifier can include any one or more of a name, street address, telephone number, email address, domain name, social security number, DUNS® number, etc. The identifier should uniquely identify the entity. Otherwise, the system requests additional identifiers for the entity.

Next, the system qualifies (at 120) the identified entity. Qualifying the entity involves identifying the entity as an individual or a business. In some embodiments, entity qualification occurs by a first set of queries to social media, directories, and other data sources using the identifier. In some embodiments, the qualification is determined from the identifier itself.

The process creates (at 130) a tuple for the entity. In some embodiments, creating the tuple involves instantiating and storing the tuple data structure to a system database.

The process performs (at 140) a second set of queries to identify and link other individuals or businesses that are associated with the entity. When the entity is qualified as a business, the second set of queries is performed in order to identify one or more individuals that have influence over the business. This can include individuals that can affect or influence the credit or credibility of the business directly or indirectly. The second set of queries attempts to identify founders, investors, and other individuals that serve as principals of the business. Inversely, when the entity is qualified as an individual, the second set of queries is performed in order to identify one or more businesses that the individual has influence over. In other words, the system identifies businesses whose credit or credibility can be directly or indirectly affected or influenced by the individual. The second sets of queries can be conducted against one or more entity databases, entity webpages, public disclosures, and government databases as some examples. As one example, when the entity identifier identifies a business, the system performs a search engine query to identify that business's webpage. The system then navigates to the business's webpage. From that webpage, the system identifies the principals of the business. In some such embodiments, the system employs web crawlers and scripts to perform the navigation and data extraction in an automated manner. In some embodiments, the information that is extracted from the webpage is used to corroborate information that is extracted from an identified entity database record. The process links (at 150) any identified associations to the tuple.

Next, the process aggregates (at 160) the personal credit and credibility information for each individual that is linked to the tuple and business credit and credibility information for each business that is linked to the tuple. At the very least, this includes aggregating the credit and credibility information for the entity to which the tuple is keyed. The process links the credit and credibility information to the appropriate individual or business of the tuple to which the information relates.

Personal credit information may include an individual's payment history, timeliness of payment, credit utilization, outstanding debt, revolving debt, lines of personal credit, credit history length, types of credit used, and credit inquiries or searches as some examples. Business credit information includes payment history, timeless of payment, credit history length, business industry, size of the business, credit inquiries or searches, presence of derogatory records (i.e., collections, liens, judgments, and bankruptcies), equity, net worth, likeliness to fail in a specified time frame, and number of trade experiences or trade references as some examples. Credit scores may also be included as part of the personal credit information and business credit information.

In some embodiments, the credit information is obtained from the entity database. In some other embodiments, partnerships are established with one or more personal and business credit reporting agencies in order to aggregate the credit information for the individuals and businesses that are associated with the tuple. In some embodiments, these primary sources of credit information are supplemented with secondary sources of credit information. The secondary sources include entity webpages, public disclosures, government databases, etc. The secondary sources may be used to corroborate credit information from the primary sources. Alternatively, the secondary sources may be used to fill in omitted or incomplete fields of credit information that are obtained from the primary sources. Additionally or alternatively, the credit information from the primary sources can be corroborated or supplemented by directly contacting the entity to which the credit information relates. The entity's contact information can be obtained either from the identifier, the entity database record, or the search engine or webpage queries. For example, the credit information for a new or small business may have some omissions because that business does not have a sufficiently long credit history. In such cases, the system can contact the entity to request the omitted credit information. Alternatively, the fields for the omitted credit information may be presented to the entity using an online interface that the entity can then populate.

Whereas credit information is primarily directed to assessing financial risk, credibility information is directed to the experiences that others have had with a particular entity. Credibility information that can be aggregated and associated with the individuals and businesses associated with the tuple can include reviews, ratings, network partnerships, critiques, social media activity, followers, accreditations, verifications, and other data related to stability, trustworthiness, transparency, and reputation of the individual or business. Credibility information can be aggregated from various online sources including social media sites, review sites, directories, websites, credibility databases, and the like. These primary sources of credibility information can also be supplemented with secondary sources including without restriction the entity itself and trade reference associated with the entity as some examples.

The credit and credibility information that is obtained from these various sources is linked (at 170) back to the individual or business of the tuple to which the information relates. The tuples are stored and accessed from a database of the hybrid entity evaluation system of some embodiments.

In some embodiments, the process optionally presents the information aggregated to a particular tuple with the entity to which the tuple relates. The entity can then verify the accuracy of the aggregated credit and credibility information. In some embodiments, the system flags any verified information to differentiate from unverified information. The flags can be used to prioritize the presentation of verified information or to designate the verified information in a holistic report or when providing the information to various lenders as described below. In some instances, the entity can also provide corrections or supplement the information with additional information. The corrections or supplemental information can be stored as part of the tuple.

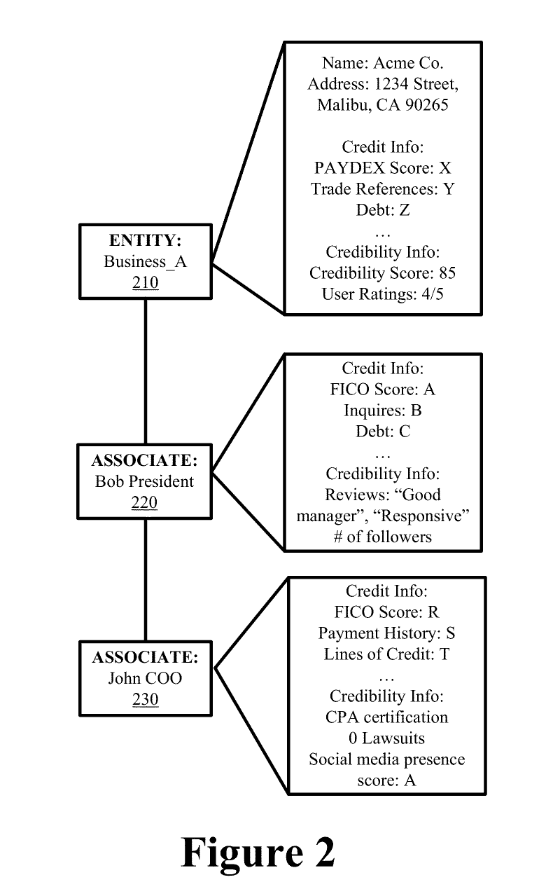

FIG. 2 conceptually presents a tuple in accordance with some embodiments. The tuple identifies a business 210 as the entity. Various identifying information, credit information, and credibility information for the business 210 is stored to the tuple as well as credit and credibility information for two individuals 220 and 230 that were identified as principals of the entity.

In some embodiments, the system provides an interface that allows administrators and users to create custom tuples or modify system generated tuples. The custom tuple can include or remove various individuals or businesses that the system otherwise automatically associates with a particular entity. For instance, the system may generate a tuple for a particular business entity that includes credit and credibility information for one business and three individuals. However, a user may only be interested in the credit and credibility information of the business and one of the three individuals. Accordingly, the user can customize the tuple to disassociate the other two individuals from the tuple. Alternatively, the user may be interested in learning about the impact that a fourth individual has on the particular business entity. In this case, the user adds the fourth individual to the tuple and the system aggregates the credit and credibility information for the fourth individual to the tuple. The tuple customization is provided to allow administrators and users the ability to customize the various functionality described below with respect to evaluating entity creditworthiness, identifying available lines of credit, producing holistic reports, and deriving hybrid credit scores.

III. Holistic Credit Evaluation

The individual-business tuple provides a comprehensive base of credit and credibility information with which the system of some embodiments can comprehensively and holistically determine the creditworthiness and capital availability for an entity. In some embodiments, the system uses this base of credit and credibility information to provide the entity with all its available credit in a single interface or report irrespective of whether the credit availability stems from the entity's personal credit information, personal credibility information, business credit information, business credibility information, or some combination thereof. In other words, the entity's credit availability is no longer solely based on the credit strength of one individual or one business, but rather a combination of credit and credibility of the entity and those having influence over or affecting the creditworthiness of the entity.

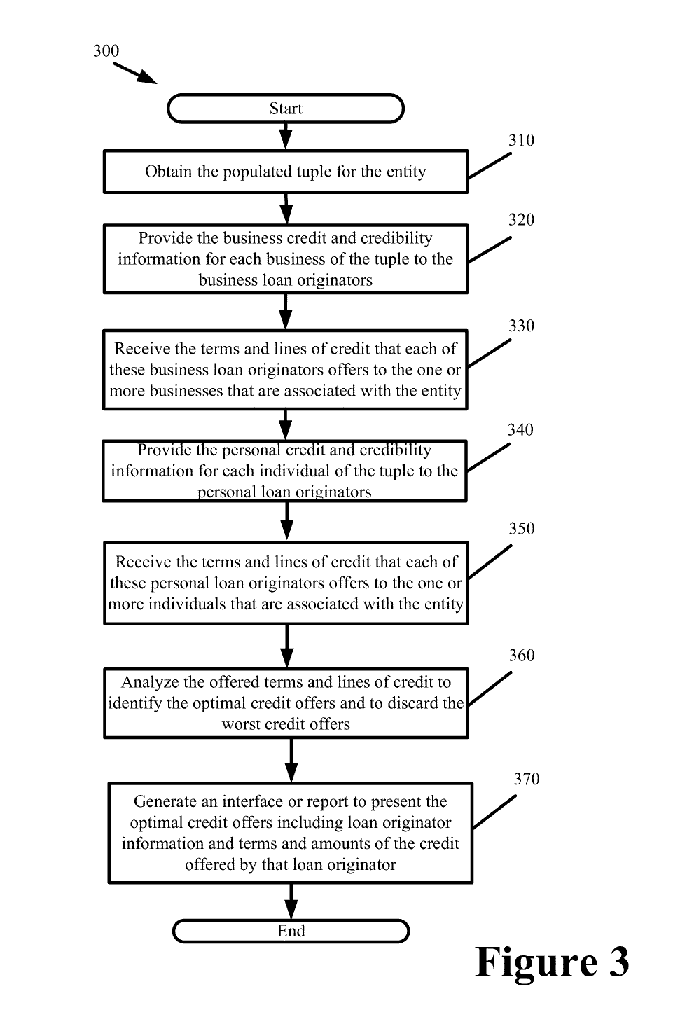

FIG. 3 presents a process 300 with which the system provides a holistic evaluation for an entity in accordance with some embodiments. The process commences by obtaining (at 310) the populated tuple for the entity. As noted above, the tuple stores the individuals and businesses that are associated with the entity as well as their credit and credibility information.

Based on partnerships that the system of some embodiments has established with business loan originators, the process provides (at 320) the business credit and credibility information for each business of the tuple to the business loan originators. In return, the process receives (at 330) the terms and lines of credit that each of these business loan originators offers to the one or more businesses that are associated with the entity. Providing both business credit and credibility information to a loan originator provides that loan originator with a more expansive set of information from which to evaluate the creditworthiness of the entity than when basing that determination solely on credit information. For example, even when the financial stability of the entity appears strong based on a long established credit history, the entity's credibility information may reveal that the entity is in the midst of a severe downturn in business that will eventually affect its financial stability and credit. Similarly, even when the financial stability of the entity appears poor because the entity is a new business without an established credit history, the entity's credibility information may reveal that the business is experiencing strong demand and growth, thereby providing reassurance as to the financial stability of that entity.

Similarly, based on partnerships that the system of some embodiments has established with personal loan originators, the process provides (at 340) the personal credit and credibility information for each individual of the tuple to the personal loan originators. In return, the process receives (at 350) the terms and lines of credit that each of these personal loan originators offers to the one or more individuals that are associated with the entity. Here again, providing both personal credit and credibility information allows the loan originators to more accurately gauge the creditworthiness of each individual than when relying solely on individual credit information. For instance, the credit score of an individual may indicate poor financial stability, however that individual's credibility information reveals reviews from several satisfied customers that serve as a precursor to improve financial stability for that individual.

In some embodiments, the partnerships provide direct communication channels with which the system can provide the credit and credibility information to the various loan originators over a data network. In some embodiments, providing the information involves completing a credit application of a loan originator on behalf of the entity using the credit and credibility information from the tuple. Alternatively, the partnerships allow the system to receive feeds from the loan originators that identify amounts and lines of credit that the loan originators extend to different entities. In such embodiments, the system matches the credit and credibility of the individuals and businesses associated with a tuple to those of the entities that are identified in the loan originator feeds in order to deduce the amounts and lines of credit that are likely to be extended to the individual and businesses.

The process analyzes (at 360) the offered terms and lines of credit to identify the optimal offers and to discard the worst offers. The process generates (at 370) at least one of an interface or report to present the optimal offers including loan originator information and terms and amounts of the credit offered by that loan originator. In some embodiments, the entity can make a selection from the interface or report. In some such embodiments, the system brokers the acquisition of the offered capital with the corresponding loan originator on behalf of the entity.

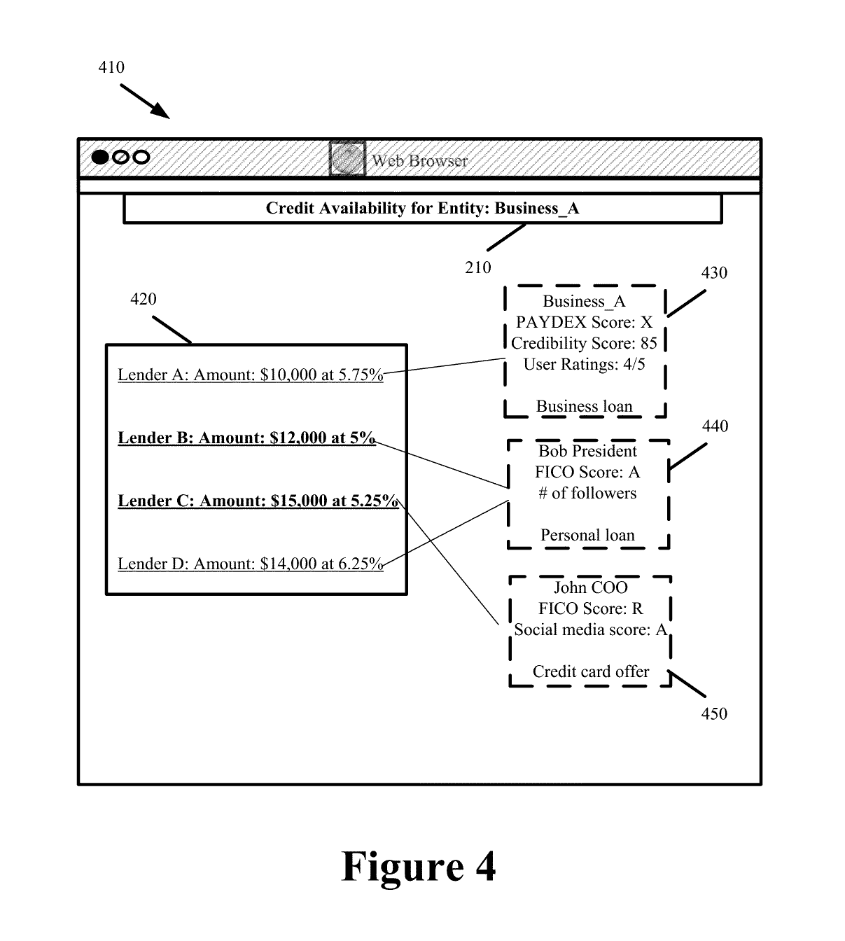

FIG. 4 presents an exemplary interface 410 presenting a holistic evaluation of the entity 210 in accordance with some embodiments. Below the identification of the entity 210, the interface 410 presents different credit offers from different loan originators 420. Those offers with the best terms are distinguished from the other offers. Additional information about each offer may be obtained through interactive means. For example, if the entity hovers over a specific offer, the interface presents a window 430, 440, or 450 that describes the credit and credibility information on which that offer is based. From this one interface 410, the entity can view its available personal credit and available business credit without having to separately shop its personal credit and credibility information to each of the personal loan originators and separately shop its business credit and credibility information to each of the business loan originators. Moreover, the interface identifies alternative sources of credit that are available to the entity that the entity may not be aware of. The exemplary interface 410 illustrates that the entity 210 would be able to get a larger line of credit using the personal credit and credibility information of its principals than using the business credit and credibility information of the business. This can be a likely scenario for many small or new businesses.

The evaluation resulting from process 300 provides one level of hybridization that unifies how an entity goes about identifying its available personal credit and business credit. Stated differently, the holistic evaluation above identifies the credit that is available to an entity irrespective as to whether that credit is offered as a result of the entity's personal credit, personal credibility, business credit, business credibility, or some combination thereof. The system thus blurs the otherwise separate lines of credit and credibility and the personal and business aspects of each.

Some embodiments provide a more passive evaluation by generating a report that combines the personal credit and credibility information of the individuals associated with a specific tuple with the business credit and credibility information of the businesses that are associated with that same tuple. Such a combined report provides greater insight than traditional credit reports that focus on just the credit of one individual or one business. Specifically, the combined report of some embodiments holistically presents the creditworthiness of all individuals and businesses that are deemed to influence the creditworthiness of a particular entity (i.e., individual or business) to which the tuple is keyed using the credit and credibility of those individuals and businesses. In so doing, the report provides a fuller disclosure of risk and a more accurate assessment of creditworthiness than traditional credit reports.

In some embodiments, the system verifies the accuracy of the reports by providing the reports to the entities to which they relate. The entities can then provide input to correct or supplement various personal and business credit and credibility information therein. The system can then provide the modified report to various lenders in order to more accurately identify the terms and lines of credit that are available to the particular entity. Moreover, in some embodiments, the system utilizes the entity input to delineate information from the report that has been verified by the entity from other information that has not been verified by the entity, but that has been sourced from various third parties.

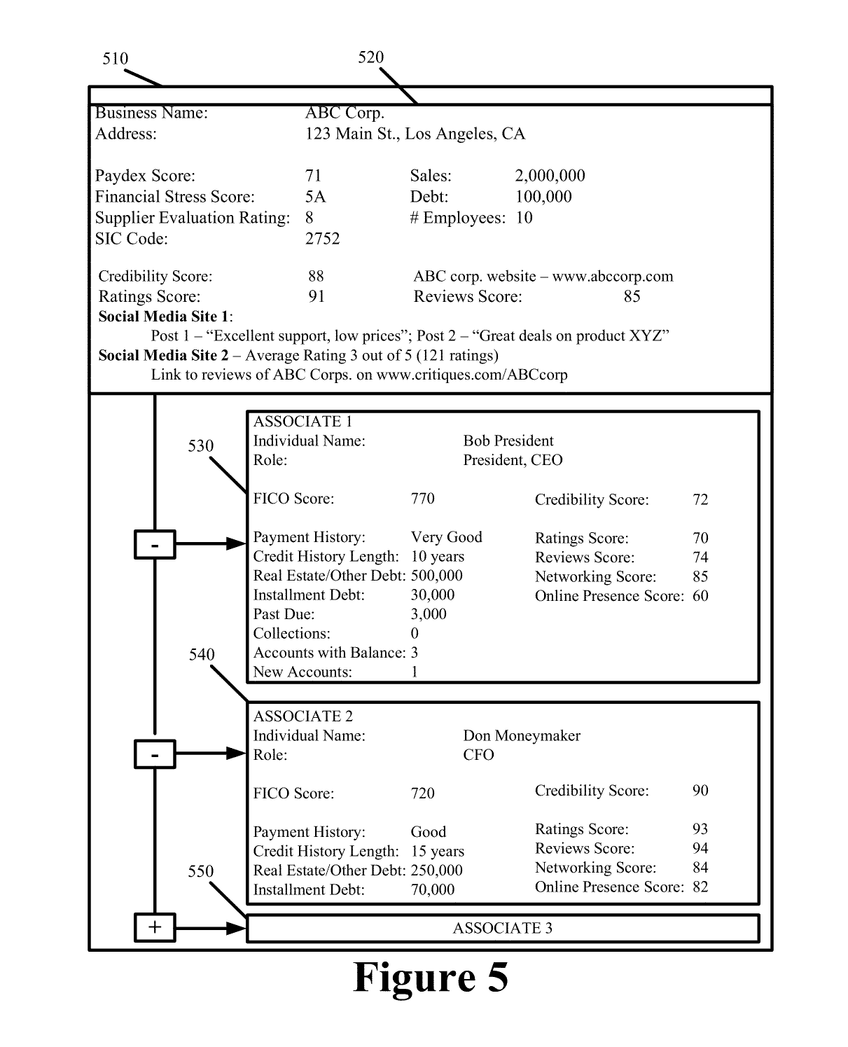

FIG. 5 presents an exemplary holistic report 510 that is derived based on the credit and credibility information from an individual-business tuple of some embodiments. In this figure, the holistic report 510 is keyed to a particular business. Accordingly, the credit and credibility information of the particular business is presented in a primary panel 520 of the holistic report 510. Secondary panels 530, 540, and 550 of the holistic report 510 present the credit and credibility information for associated individuals that have been determined to have influence on or affect the creditworthiness of the particular business.

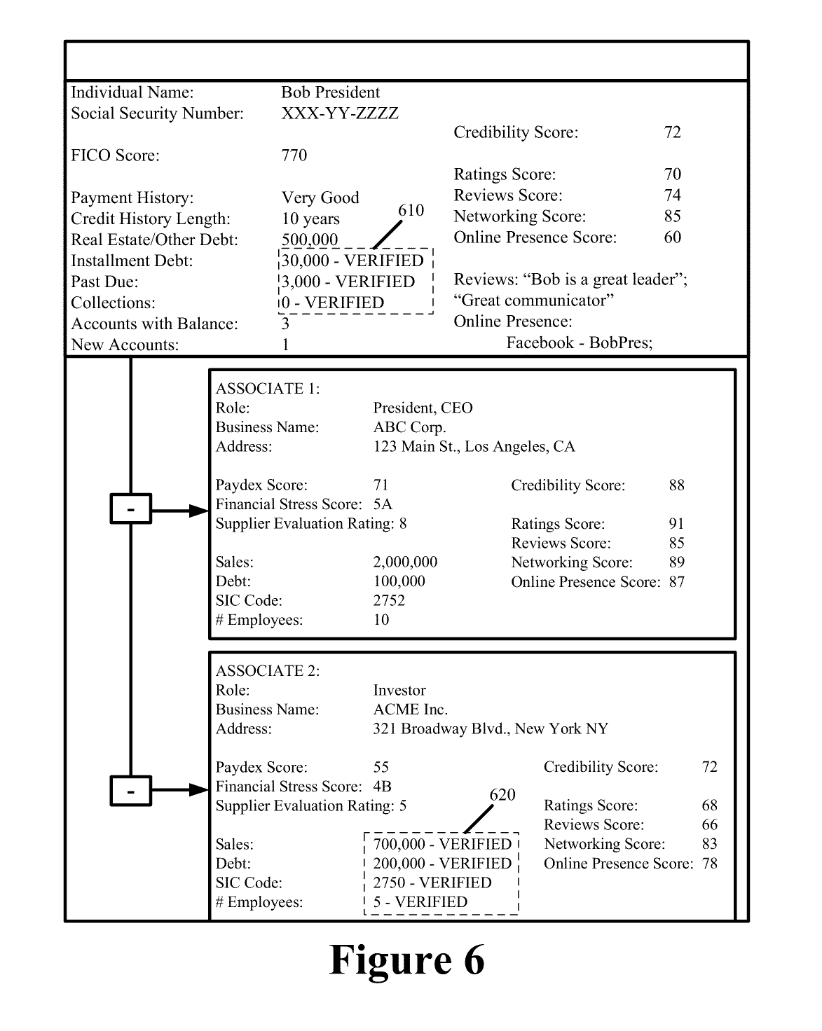

FIG. 6 presents an alternative holistic report that is keyed to a particular individual and that shows credit and credibility information of the particular individual as well as credit and credibility information for businesses whose creditworthiness the particular individual can influence. This report also identifies information 610 and 620 within the report that has been verified by the particular individual. The verification is a result of presenting the information to the particular individual and receiving confirmation from the particular individual that the information is accurate.

In some embodiments, the holistic report can be customized to present the credit and credibility information for only the businesses and individuals of a tuple that is of interest to a viewer. These customizations allow the user to specify which businesses and individuals are included in the holistic report as well as what credit and/or credibility information is to be included for each business and individual of the tuple.

IV. Hybrid Credit Evaluation

Some embodiments provide a deeper level of hybridization in which an entity's creditworthiness is derived by combining credit and credibility as well as the personal and business aspects of each. This deeper level of hybridization is principled on several realizations. One such realization is that credit is not mutually exclusive of credibility and that the personal aspects of credit and credibility can have an affect on the business aspects of credit and credibility. Another realization is that personal credit scores are derived using some of the same metrics or criteria as those used in the derivation of business credit scores and personal credibility scores. These realizations can be seen by the examples that changes to personal credit can have a real direct or indirect affect on personal credibility and changes to personal credit can have a real direct or indirect affect on business credit. The inverse of these examples also holds true. Thus, it is understood that credit and credibility should not be derived independent of one another, nor should personal credit and business credit, personal credibility and business credibility, or different combinations thereof.

In view of the foregoing, some embodiments leverage the credit and credibility personal and business information that is linked to a tuple as a basis for performing an information gap filling methodology. The gap filling methodology supplements insufficient credit information or cures lacking credit information for any individual or business that is associated with an entity tuple using complimentary or derived credit or credibility information from any individual or business of the same entity tuple. In this manner, the system can produce a complete profile of personal credit information for a given individual entity by supplementing insufficient or lacking items of the personal credit information with business credit information from a business that is associated with that individual in the same entity tuple or with personal credibility information from that individual or other individuals and businesses in the same entity tuple. Inversely, the system can produce a complete profile of business credit information for a given business entity by supplementing insufficient or lacking items of the business credit information with personal credit information from an individual that is associated with the business in the same entity tuple or with business credibility information from that business or other businesses and individuals in the same entity tuple. Loan originators can then perform a complete and comprehensive credit evaluation of the entity without penalizing the entity for insufficient or lacking information within the credit profile. Consequently, more loan originators will be willing to lend to the entity and more will do so with improved terms than if the entity was to apply with a credit profile that included insufficient or lacking credit information.

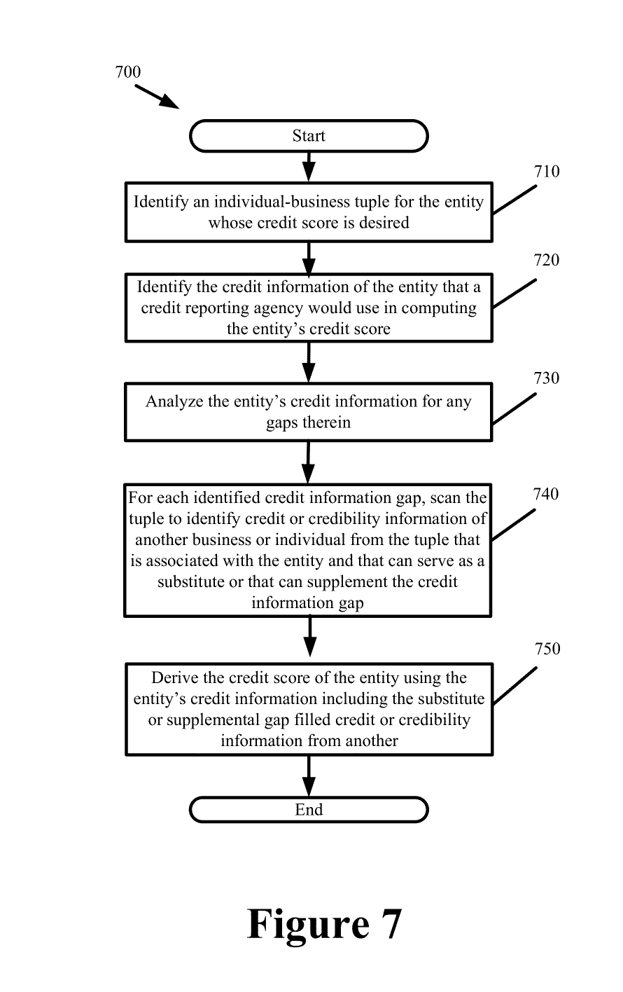

FIG. 7 presents a process 700 for performing the gap filling methodology in accordance with some embodiments. The process begins by obtaining (at 710) an individual-business tuple for a particular entity. From the tuple, the process identifies (at 720) the credit information of the particular entity that a credit reporting agency would ordinarily use in computing the particular entity's credit score. Since credit reporting agencies rely on long established formulas for the computation of their credit scores, the credit information used in these computations is readily known. For simplicity and brevity, the list of credit information used in computing personal credit scores, such as the FICO score, and business credit scores, such as the PAYDEX score, is omitted from this discussion, but it is expected that one of ordinary skill in the art has knowledge of the relevant credit information.

The process analyzes (at 730) the entity's credit information for any gaps therein. A gap includes any item of credit information that is lacking, obsolete, or for which there is insufficient information. Insufficient information may result from an insufficient sampling, too small of a time frame, or insufficient number of prior value sets. Lacking or insufficient credit information may also arise from a lack of reporting or recording of the credit information.

For each identified credit information gap, the process scans (at 740) the tuple to identify credit or credibility information of another business or individual that is associated with the entity and that can serve as a substitute or that can supplement the credit information gap. In some embodiments, the substitute or supplemental credit or credibility information need not be a direct substitute for the credit information that is lacking or insufficient. In such cases, the substitute or supplemental credit or credibility information is processed to derive replacement credit information. The processing can involve reformatting, scaling, or otherwise adjusting the substitute or supplemental credit or credibility information so that it may be used in place of or in addition to the lacking or insufficient credit information. For example, personal debt may be one item of credit information that can serve as a direct substitute for business debt, whereas personal income/revenue may be an item of credit information that has to be rescaled for use as a substitute to business income/revenue. Similarly, business credit scores are in part derived based on the number and quality of trade references that are associated with the business. When there is an insufficient number of trade references, business credibility information including user reviews about the business can potentially be used as a direct or indirect substitute for the trade references.

The entity's credit information including the substitute or supplemental gap filled credit or credibility information from another is then used to derive (at 750) the credit availability of the entity. In some embodiments, the entity's credit information including the substitute or supplemental gap filled credit or credibility information is passed to one or more loan originators to determine the terms and lines of credit the loan originators are willing to offer the entity. In some embodiments, the gap filled credit information is used in computing a revised credit score for the entity. The revised credit score can then be provided to various loan originators.

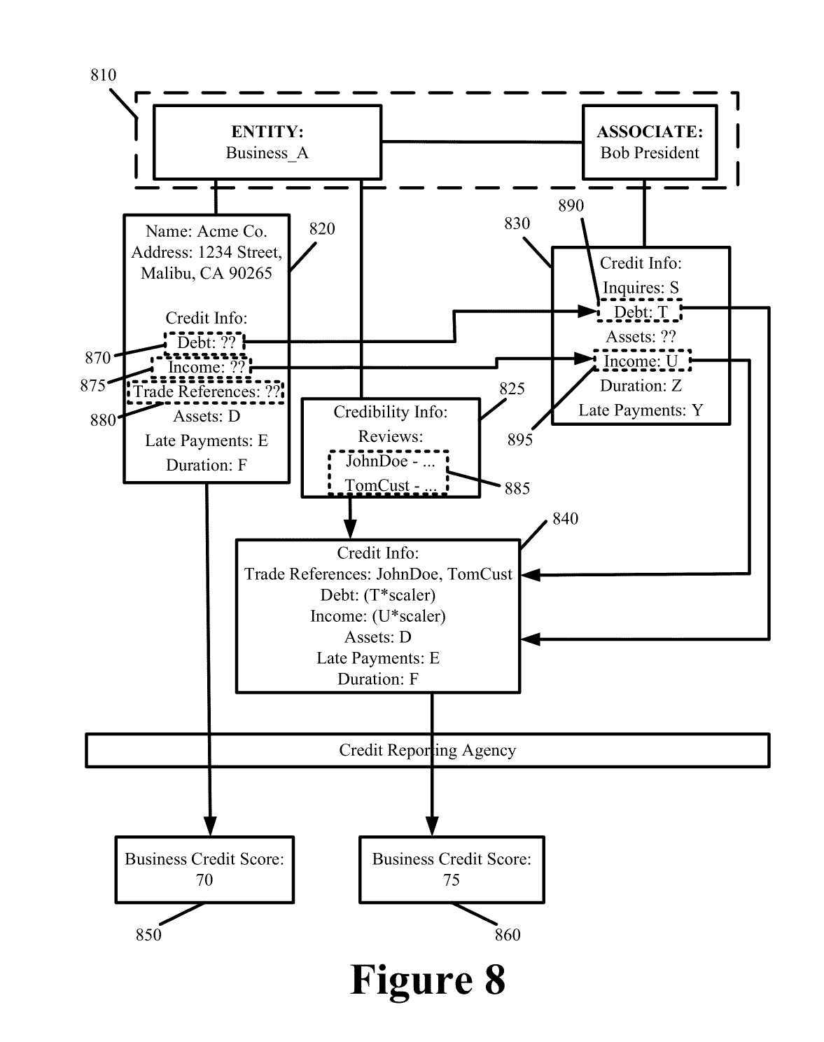

FIG. 8 conceptually illustrates using the gap filling methodology to generate a revised credit score in accordance with some embodiments. The figure illustrates entity tuple 810, business credit information 820 from the tuple 810, business credibility information 825 from the tuple 810, personal credit information 830 from the tuple 810, a gap filled adaptation of the business credit information 840, a first business credit score 850 output based on the original set of business credit information, and a second business credit score 860 output based on the gap filled adaptation of the business credit information.

To compute the revised credit score for an entity, the system first obtains the tuple 810 for that entity. In this example, the entity is a business and the revised credit score is a business credit score for the business. The business credit information 820 from the tuple 810 pertains to the business. This is ordinarily the set of credit information that a business credit reporting agency would use to compute the business credit score for the business. As shown however, items 870, 875, and 880 from the business credit information 820 are insufficient or lacking and are thus gaps in the business credit information 820. The system looks to fill these gaps with substitute or supplemental credit information from the tuple 810.

The system identifies that the tuple 810 includes business credibility information 825 for the business and personal credit information 830 for an individual that is a principal of the business. The system also identifies that items 890 and 895 from the personal credit information 830 can be used directly or as derived substitutes for the business credit information gaps 870 and 875. Specifically, the system substitutes the missing business credit debt and income information with personal credit debt and income information from the associated individual that is identified as part of the tuple 810. The system also identifies that items 885 from the business credibility information 825 can be used indirectly as substitutes for the business credit information gap 880. Here, the system replaces the business credit trade reference information with business credibility review information. These substitutions and supplementations produce the gap filled adaption of the business credit information 840. The gap filled adaptation of the business credit information 840 thus provides a complete set of business credit information that is compiled from the business' own business credit information 820, the business' credibility information 825, and from the personal credit information 830 of the individual that can influence or otherwise affect the creditworthiness of the business. In this figure, the second business credit score 860 resulting from the gap filled adaptation of the business credit information 840 is a higher score connoting greater creditworthiness than the first business credit score 850, because the business is no longer penalized for insufficient or lacking items 870, 875, and 880 that detrimentally affect the business' creditworthiness.

In performing the gap filling methodology, the entity evaluation system of some embodiments obtains or confirms credit information for the entity being scored. This is made possible using the information that is linked to the tuple. Specifically, the tuple contains contact information for the entity as part of the entity identifying information. Accordingly, should the system spot lacking or insufficient credit information for the entity, the system can contact the entity using the contact information to obtain the lacking or insufficient credit information. Contacting the entity may include submitting an electronic message such as an email that identifies the lacking or insufficient items of credit or credibility information. The entity can then respond with the requested information. In some embodiments, the response is verified for accuracy. Additionally, the electronic message can be used to confirm information when conflicting information is obtained from two different sources. Other forms of contacting the entity include sending text messages or placing a telephone call and providing audible prompts or speaking to a live representative to obtain or confirm the information.

In the disclosures above, the system supplements deficiencies in the credit information of a particular entity with credit and credibility information of associated individuals and businesses. In some embodiments, the system leverages the credit and credibility information of the entity and the individuals and businesses associated with the entity regardless of any deficiencies in the credit information of the particular entity. In some such embodiments, the system leverages the multiple credit and credibility information sets in order to generate an altogether new hybrid credit score.

Like traditional personal credit scores and business credit scores, the hybrid credit score is any alphanumeric or symbolic representation on a quantified scale. However unlike traditional personal credit scores and business credit scores, the hybrid credit score comprehensively represents the creditworthiness of the particular entity by accounting for the credit and credibility of the particular entity and by also accounting for the credit and credibility of those individuals and businesses that can influence the creditworthiness of the particular entity. The hybrid credit score is thus a multi-dimensional representation of creditworthiness. Traditional personal credit scores and business credit scores are single dimensional, because they are derived from the credit information of a single individual or business, whereas the hybrid credit score is derived from credit and credibility and from personal and business aspects of each.

The hybrid credit score prevents an entity from hiding its past. For instance, the delineation of credit and credibility as well as the delineation between personal information and business information in the prior art allowed an individual with a troubled personal credit history and an operating business to simply leverage its business credit to acquire the capital it needs for personal needs. Similar misappropriations can result in the prior art when a business with a troubled credit history leverages the creditworthiness of its principals for business capital. The hybrid credit score, which is based on the coalescing of credit and credibility and personal and business aspects of each, prevents such abuses.

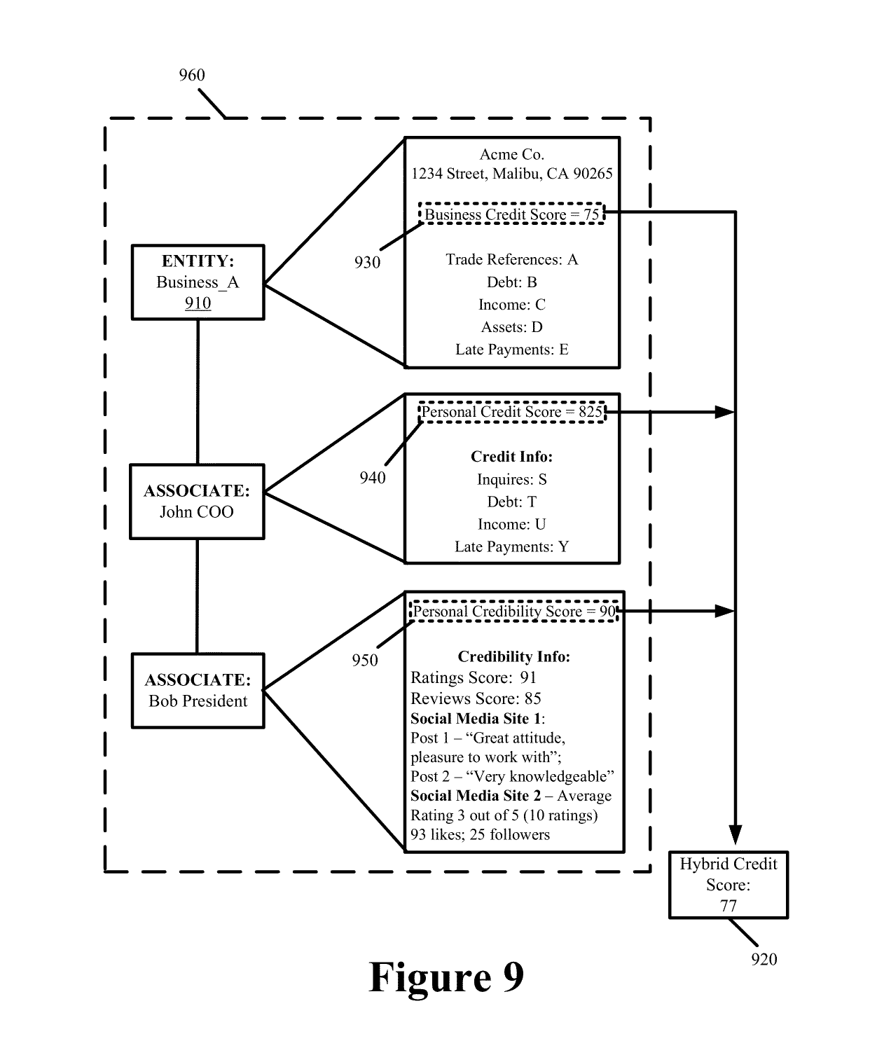

In accordance with some embodiments, FIG. 9 illustrates deriving the hybrid credit score for an entity by adjusting an existing credit score of the entity based on credit and credibility scores of individuals or businesses that are associated with the entity in the same tuple. Specifically, this figure is directed to a business entity 910 and producing a hybrid credit score 920 by adjusting a business credit score of the business 930 based on a credit score 940 of a first principal of the business and a credibility score 950 of a second principal of the business.

First, the tuple 960 for the business entity 910 is obtained. From the tuple 960, the system identifies the business credit score 930 of the business 910. As shown, the business 910 has an existing PAYDEX business credit score 930 of 75. From the tuple 960, the system also retrieves the personal credit score 940 for a first individual or principal that is associated with the business 910 and the personal credibility score 950 for a second individual or principal that is associated with the business 910, wherein the first and second individuals have been determined to have influence over or affect the creditworthiness of the business entity 910.

The system then produces the hybrid credit score 920 by adjusting the business credit score 930 according to the creditworthiness contribution of the personal credit score 940 and the personal credibility score 950. In this figure, the system generates a hybrid credit score 920 of 77, whereby the original business credit score 930 is increased based on the creditworthiness of the individuals that are associated with the business 910. In some embodiments, the hybrid credit score 920 can be provided to business loan originators in addition to or instead of the original business credit score 930. The business loan originators can then base their credit evaluation on the more comprehensive hybrid credit score which also factors personal credit and credibility of the business principals.

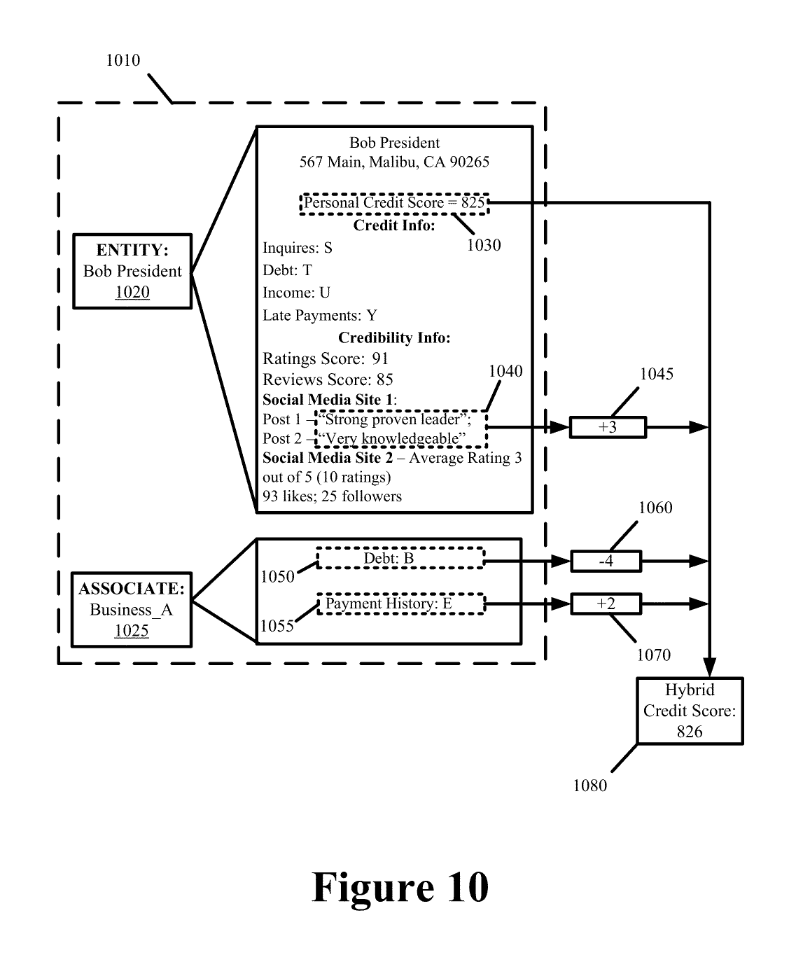

In accordance with some embodiments, FIG. 10 illustrates another methodology for deriving the hybrid credit score by adjusting an existing credit score using credit information and credibility information of individuals or businesses that are associated with the entity in the same tuple. Again, the tuple 1010 for an entity 1020 is obtained and the entity's credit score 1030 is obtained from the tuple 1010. In this figure, the entity 1020 is an individual with a FICO personal credit score 1030 of 825.

From the tuple 1010, the system retrieves personal credibility information directed to entity 1020. In this figure, the retrieved personal credibility information includes posts 1040 that others have written about the entity 1020. The system processes these posts 1040 to determine the sentiment expressed therein. Based on the sentiment from these posts, the system computes a first creditworthiness contribution or impact score 1045. As conceptually shown, the creditworthiness impact score is an amount by which each relevant item of personal credibility information increases or decreases the existing personal credit score 1030 of the entity. The creditworthiness impact score can be computed relative to the personal credit score 1030 or independent thereof.

From the tuple 1010, the system also retrieves the business credit information for a business 1025 that is associated with the individual 1020. As before, this can be a business that the individual is a principal of. Relevant items of the business credit information are then processed. The relevant items can include those that directly or indirectly affect personal creditworthiness. In some embodiments, the relevant items can include the entirety of the available business credit information. In this figure, the illustrated items of business credit information affecting the personal credit score are the outstanding debt 1050 and payment history 1055 of the business 1025. The system computes a creditworthiness impact score 1060 and 1070 for each relevant item of business credit information 1050 and 1055. In this figure, the business 1025 has an excessive amount of outstanding debt 1050 that negatively impacts the personal credit score 1030. The business 1025 however has good payment history 1055 that positively impacts the personal credit score 1030.

The system then produces the hybrid credit score 1080 by adjusting the personal credit score 1030 according to the creditworthiness contribution or impact scores 1045, 1060, and 1070. In this figure, the personal credit score 1030 is adjusted using personal credibility information of the entity 1020 and business credit information 1040 and 1050 of a business that is associated with the entity 1020. In this figure, the system generates a hybrid credit score 1080 of 826, whereby the original personal credit score 1030 is increased by three points because of the positive sentiment from the personal credibility information, decreased by four points because of the large amount of outstanding business debt 1040, and increased by one point by the good payment history 1050 of the business 1025. This hybrid credit score 1080 can be provided to personal loan originators to allow for a more comprehensive credit evaluation of the individual than when basing the evaluation solely on a personal credit score or personal credit information.

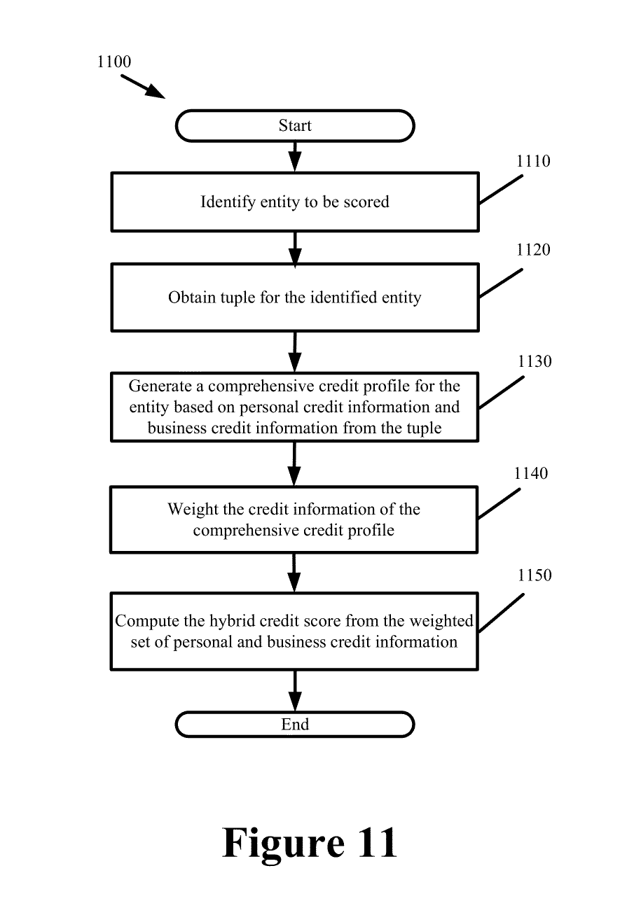

In accordance with some embodiments, FIG. 11 presents a process 1100 for deriving the hybrid credit score by coalescing personal and business credit and credibility information. The process begins by identifying (at 1110) an entity to score. Next, the process obtains (at 1120) the tuple for the identified entity, wherein the tuple identifies the individuals and businesses that are associated with the entity. The tuple also provides the credit and credibility information that was aggregated for the individuals and businesses associated with the entity.

The process amalgamates the personal and business credit and credibility information from the tuple to generate (at 1130) a comprehensive credit profile for the entity. As part of the amalgamation, the process attributes (at 1140) weights to the credit and credibility information. The weights determine how much each item of credit information and each item of credibility information contributes to the overall hybrid credit score. Greater weight is provided to the business information when the entity being scored is a business and greater weight is provided to the personal information when the entity being scored is an individual.

The process computes (at 1150) the hybrid credit score from the weighted set of personal and business credit and credibility information. For example, when computing the hybrid credit score for an individual entity, the process may derive 30% of the hybrid credit score on the individual's payment history, 25% on the individual's debt or amounts owed, 10% on length of the individual's credit history, 5% on new lines of credit opened by the individual, 10% on sentiment expressed in reviews included as part of the personal credibility information, 15% on the payment history of any businesses that are associated with the individual, and another 5% on the credibility of the businesses that are associated with the individual.

The hybrid credit score can be stored to a database or presented through an interface. In some embodiments, computation of the hybrid credit score is based on credit scores and credibility scores of an entity and those individuals and businesses that are associated with the entity.

In some embodiments, the system provides the hybrid credit score to various loan originators on behalf of an entity. The hybrid credit score may be provided in addition to the personal credit scores and business credit scores that are associated with the entity. In other words, process 300 of FIG. 3 can be modified to include steps for providing the hybrid credit score to various loan originators, receiving the terms and lines of credit that each of the loan originators offer to the entity, and including the terms and lines of credit in an interface or report. The capital that is available to the entity based on the hybrid credit score, personal credit score, business credit score, or some combination thereof may be presented in an interface similar to the one described with reference to FIG. 4 above.

V. Computer System

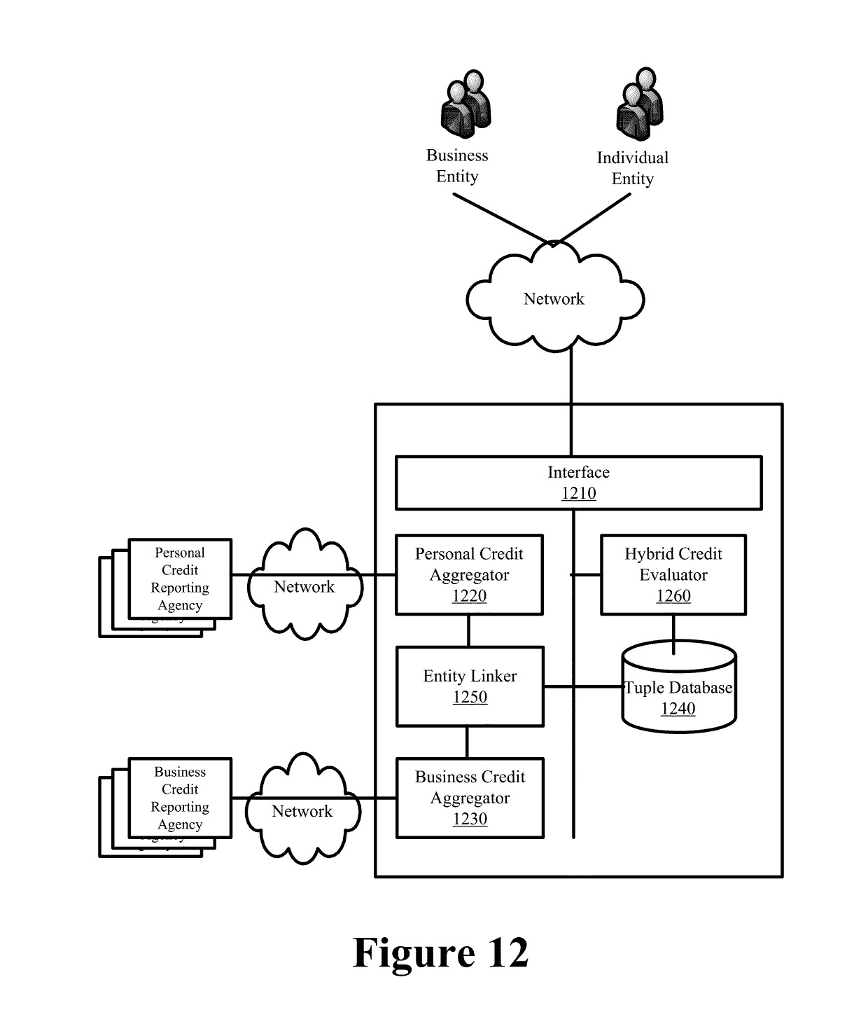

FIG. 12 illustrates components of the hybrid entity evaluation system of some embodiments. As shown, the system includes interface 1210, personal and business credit aggregator 1220, personal and business credibility aggregator 1230, tuple database 1240, entity linker 1250, and hybrid entity evaluator 1260.

The interface 1210 provides the interactive means with which entities can request the holistic reports, provide information to initiate the holistic reporting, and present the holistic reports to the various entities. The personal and business credit aggregator 1220 communicably couples to various personal and business credit reporting agencies and aggregates the credit information and credit scores for the individuals and businesses that are linked to the various tuples. Similarly, the personal and business credibility aggregator 1230 communicably couples to various sources of credibility information in order to retrieve the credibility information for the individuals and businesses that are linked to the various tuples. Source of credibility information include review and rating websites (e.g., Yelp), social media sites (e.g., Facebook, LinkedIn, etc.), individual and business websites, and accreditation sites (e.g., the Better Business Bureau) as some examples. The credit aggregator 1220 and the credibility aggregator 1230 communicably couple to the respective data sources using one or more network interfaces. In some embodiments, the aggregators 1220 and 1230 are provided access to the credit and credibility information from the various sources as a result of pre-negotiated agreements or data sharing agreements. The tuple database 1240 stores the tuples that are generated by the system. This includes storing the data structure itself as well as the entity information and credit and credibility information for those entities that are linked to a tuple. The entity linker 1250 constructs the tuples. The entity linker 1250 receives at least one identifier for an entity. The entity linker 1250 queries the tuple database 1240 to determine if a tuple has been constructed for the identified. If not, a new tuple is generated. The entity linker 1250 then scans an entity database or other informational sources to identify the other entities that should be linked to the identified entity before obtaining the credit information for each of the entities. The hybrid entity evaluation 1260 is the component that computes the various hybrid credit scores, performs the gap filling methodologies, and generates the interfaces and reports described above.

Many of the above-described processes and components are implemented as software processes that are specified as a set of instructions recorded on a non-transitory computer-readable storage medium (also referred to as computer-readable medium). When these instructions are executed by one or more computational element(s) (such as processors or other computational elements like ASICs and FPGAs), they cause the computational element(s) to perform the actions indicated in the instructions, thereby transforming a general purpose computer to a specialized machine implementing the methodologies and systems described above. Computer and computer system are meant in their broadest sense, and can include any electronic device with a processor including cellular telephones, smartphones, portable digital assistants, tablet devices, laptops, desktops, and servers. Examples of computer-readable media include, but are not limited to, CD-ROMs, flash drives, RAM chips, hard drives, EPROMs, etc.

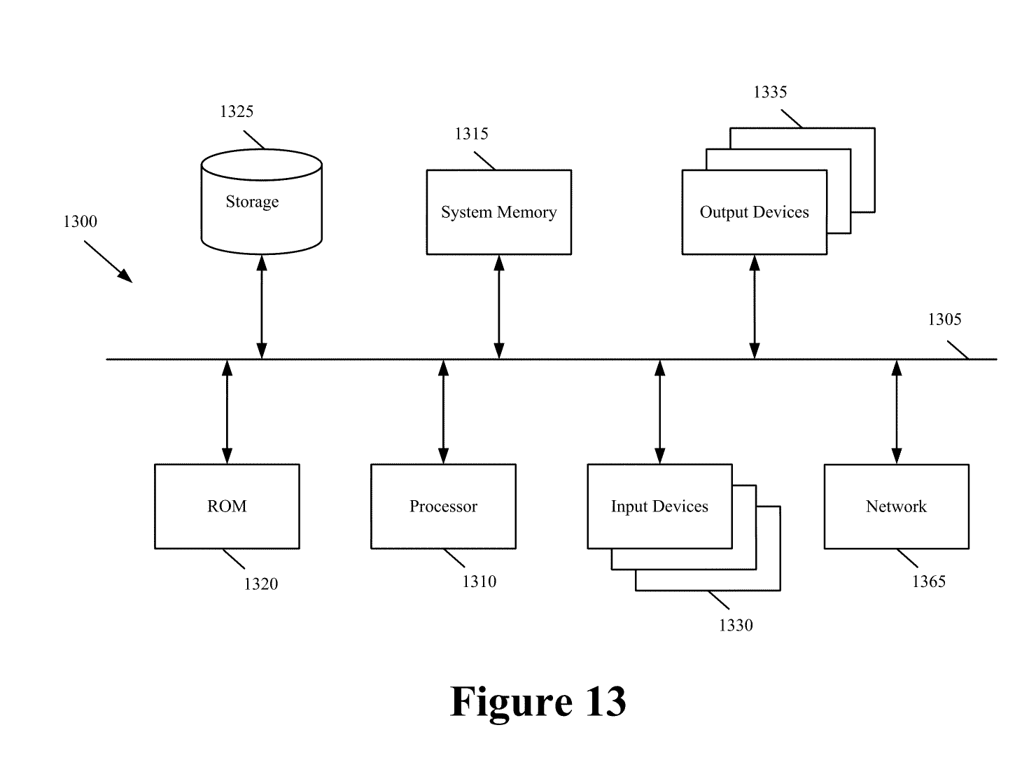

FIG. 13 illustrates a computer system with which some embodiments are implemented. Such a computer system includes various types of computer-readable mediums and interfaces for various other types of computer-readable mediums that implement the various processes, modules, and systems described above (e.g., interface 1210, personal credit aggregator 1220, business credit aggregator 1230, tuple database 1240, entity linker 1250, and hybrid entity evaluator 1260). Computer system 1300 includes a bus 1305, a processor 1310, a system memory 1315, a read-only memory 1320, a permanent storage device 1325, input devices 1330, and output devices 1335.

The bus 1305 collectively represents all system, peripheral, and chipset buses that communicatively connect the numerous internal devices of the computer system 1300. For instance, the bus 1305 communicatively connects the processor 1310 with the read-only memory 1320, the system memory 1315, and the permanent storage device 1325. From these various memory units, the processor 1310 retrieves instructions to execute and data to process in order to execute the processes of the invention. The processor 1310 is a processing device such as a central processing unit, integrated circuit, graphical processing unit, etc.

The read-only-memory (ROM) 1320 stores static data and instructions that are needed by the processor 1310 and other modules of the computer system. The permanent storage device 1325, on the other hand, is a read-and-write memory device. This device is a non-volatile memory unit that stores instructions and data even when the computer system 1300 is off. Some embodiments of the invention use a mass-storage device (such as a magnetic or optical disk and its corresponding disk drive) as the permanent storage device 1325.

Other embodiments use a removable storage device (such as a flash drive) as the permanent storage device Like the permanent storage device 1325, the system memory 1315 is a read-and-write memory device. However, unlike the storage device 1325, the system memory is a volatile read-and-write memory, such as random access memory (RAM). The system memory stores some of the instructions and data that the processor needs at runtime. In some embodiments, the processes are stored in the system memory 1315, the permanent storage device 1325, and/or the read-only memory 1320.

The bus 1305 also connects to the input and output devices 1330 and 1335. The input devices enable the user to communicate information and select commands to the computer system. The input devices 1330 include any of a capacitive touchscreen, resistive touchscreen, any other touchscreen technology, a trackpad that is part of the computing system 1300 or attached as a peripheral, a set of touch sensitive buttons or touch sensitive keys that are used to provide inputs to the computing system 1300, or any other touch sensing hardware that detects multiple touches and that is coupled to the computing system 1300 or is attached as a peripheral. The input devices 1330 also include alphanumeric keypads (including physical keyboards and touchscreen keyboards), pointing devices (also called “cursor control devices”). The input devices 1330 also include audio input devices (e.g., microphones, MIDI musical instruments, etc.). The output devices 1335 display images generated by the computer system. The output devices include printers and display devices, such as cathode ray tubes (CRT) or liquid crystal displays (LCD).

Finally, as shown in FIG. 13, bus 1305 also couples computer 1300 to a network 1365 through a network adapter (not shown). In this manner, the computer can be a part of a network of computers such as a local area network (“LAN”), a wide area network (“WAN”), or an Intranet, or a network of networks, such as the internet. For example, the computer 1300 may be coupled to a web server (network 1365) so that a web browser executing on the computer 1300 can interact with the web server as a user interacts with a GUI that operates in the web browser.

As mentioned above, the computer system 1300 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, and any other optical or magnetic media.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for evaluating creditworthiness of a particular business based in part on creditworthiness of at least an individual associated with the particular business, the method comprising:
with at least one machine comprising a processor:
searching for any of a founder, investor, or principal with controlling influence over the particular business, wherein said searching identifies the individual as one of a founder, investor, or principal of the particular business;
aggregating a business credit profile containing business credit information about the particular business and a personal credit profile containing personal credit information about the individual;
identifying a gap in the business credit profile of the particular business, wherein the gap is one of incomplete, missing, or obsolete business credit information within the business credit profile of the particular business;
producing a supplemented business credit profile for the particular business by filling the gap in the business credit profile of the particular business with related personal credit information from the personal credit profile of the individual; and
evaluating creditworthiness of the particular business based on the business credit information of the particular business and the personal credit information of the individual from the supplemented business credit profile.

2. (canceled)

3. (canceled)

4. The method of claim 1, wherein evaluating creditworthiness of the particular business comprises producing a hybrid credit score from the business credit information of the particular business and the personal credit information of the individual included as part of the supplemented business credit profile.

5. The method off of claim 4, wherein evaluating creditworthiness of the particular business further comprises presenting a line of credit that a loan originator offers the particular business in response to the hybrid credit score.

6. (canceled)

7. The method of claim 1, wherein evaluating creditworthiness of the particular business comprises submitting the business credit information of the particular business and the personal credit information of the individual included as part of the supplemented business credit profile to a loan originator and receiving in response to said submitting, a line of credit that the loan originator offers to the particular business on the basis of the business credit information and the personal credit information from the supplemented business credit profile.

8. A method for evaluating creditworthiness of an individual based in part on creditworthiness of at least a business under influence of the individual, the method comprising:
with at least one machine comprising a processor:
generating a tuple comprising identifiers identifying the individual and a first set of personal credit information about the individual;
identifying the individual as having a controlling influence over the business as a result of the individual being one of a founder, investor, or principal of the business;
linking the business to the tuple as a result of identifying the individual having some direct or indirect controlling influence over the business;
aggregating to the tuple, a second set of business credit information about the business to supplement the first set of personal credit information about the individual; and
producing from the tuple, a combined credit report comprising the first set of personal credit information about the first entity individual and the second set of business credit information about the business.

9. The method of claim 8 further comprising applying for credit on behalf of the individual at a first loan originator using the first set of personal credit information and at a second different loan originator using the second set of business credit information.

10. The method of claim 9 further comprising presenting capital that is available to the individual by presenting a first line of credit that the first loan originator offers in response to the first set of personal credit information and a second line of credit that the second loan originator offers in response to the second set of business credit information.

11. (canceled)

12. The method of claim 10, wherein the first loan originator offers a personal loan line of credit in response to the first set of personal credit information without any business credit information, and wherein the second loan originator offers a business loan line of credit in response to the second set of business credit information without any personal credit information.

13. The method of claim 8 further comprising computing a hybrid credit score from the first set of personal credit information about the individual and the second set of business credit information about the business.

14. The method of claim 13 further comprising applying for credit on behalf of the individual at a loan originator using the hybrid credit score and presenting in combination with the combined credit report, a line of credit that the loan originator offers in response to the hybrid credit score.

15. A non-transitory computer-readable storage medium with an executable program stored thereon, wherein the program instructs a microprocessor to perform sets of instructions for:
obtaining business credit information pertaining to a first business entity qualified as a business;
identifying from the first business entity, a second individual entity qualified as an individual impacting creditworthiness of the business with the second individual entity being distinct and separate from the first business entity;
obtaining personal credit information and personal credibility information of the second individual entity; and
deriving a single credit score from the business credit information of the first business entity and at least one of the personal credit information and personal credibility information of the second individual entity, wherein deriving the credit score comprises increasing a value of the credit score when the personal credit information or the personal credibility information of the second individual entity connotes greater creditworthiness than the business credit information of the first business entity and decreasing the value when the personal credit information or personal credibility information connotes lesser creditworthiness than the business credit information.

16. The non-transitory computer-readable storage medium of claim 15, wherein the program further instructs the microprocessor to perform a set of instructions for passing the credit score to a loan originator and presenting a line of credit that the loan originator offers to the first business entity in response to passing of the credit score.

17. The non-transitory computer-readable storage medium of claim 15, wherein the program further instructs the microprocessor to perform a set of instructions for presenting a credit report comprising the credit score, the business credit information of the first business entity, and the personal credit information of the second individual entity in response to an inquiry to creditworthiness of the first business entity.

18. The non-transitory computer-readable storage medium of claim 15, wherein the program further instructs the microprocessor to perform a set of instructions for identifying a third individual entity that is an individual which can impact creditworthiness of the business and further adjusting the credit score according to creditworthiness of the third individual entity.

19. The non-transitory computer-readable storage medium of claim 15, wherein the program further instructs the microprocessor to perform a set of instructions for storing said credit score, business credit information, and personal credit information to a particular data structure created for the first business entity.

20. The non-transitory computer-readable storage medium of claim 15, wherein the program further instructs the microprocessor to perform a set of instructions for generating (i) a query interface comprising an input field for users to query creditworthiness of an entity and (ii) a result interface presenting the credit score, business credit information of the first business entity, and personal credit information of the second individual entity in response to a query for creditworthiness of the first business entity.

21. The method of claim 1 further comprising outputting a report presenting the creditworthiness of the particular business in conjunction with the business credit information and the personal credit information from the supplemented business profile.

22. The method of claim 1 further comprising outputting a report comprising the business credit information from the business credit profile of the particular business and the personal credit information from the personal credit profile of the individual.
